(19) United States
(12) Patent Application Publication
(10) Pub. No.: US 2023/0130192 A1
(43) Pub. Date: Apr. 27, 2023

(54) VEHICLE STEERING SYSTEM, REACTION TORQUE CONTROL METHOD, AND NON-TRANSITORY COMPUTER-READABLE STORAGE MEDIUM

(71) Applicant: TOYOTA JIDOSHA KABUSHIKI KAISHA, Toyota-shi Aichi-ken (JP)

(72) Inventors: Kosuke AKATSUKA, Mishima-shi Shizuoka-ken (JP); Rio SUDA, Toyota-shi Aichi-ken (JP)

(73) Assignee: TOYOTA JIDOSHA KABUSHIKI KAISHA, Toyota-shi Aichi-ken (JP)

(21) Appl. No.: 17/970,264

(22) Filed: Oct. 20, 2022

(30) Foreign Application Priority Data
Oct. 26, 2021 (JP) 2021-174917

(51) Int. Cl. B62D 6/00; B62D 5/04

(52) U.S. Cl. CPC B62D 6/008; B62D 5/0469

(57) ABSTRACT

The vehicle steering system includes a controller for controlling the reaction device for applying reaction torque to a steering wheel. The controller sets a virtual end angle corresponding to a turning limit of a turning device with respect to a steering angle. When the steering angle approaches the virtual end angle, the controller gradually increases the reaction torque as the steering angle approaches the virtual end angle. On the other hand, when the steering angle deviates from the virtual end angle, the controller decreases the reaction torque with respect to the change in the steering angle at a steeper gradient than the gradient of the change in the reaction torque with respect to the change in the steering angle when the steering angle approaches the virtual end angle.

### CROSS-REFERENCE TO RELATED APPLICATION

The present application claims priority under 35 U.S.C. § 119 to Japanese Patent Application No. 2021-174917, filed Oct. 26, 2021, the contents of which application are incorporated herein by reference in their entirety.

### BACKGROUND

### Field

The present disclosure relates to a vehicle steering system, a reaction torque control method, and non-transitory computer-readable storage medium storing a reaction torque control program. Specifically, the present disclosure relates to a steering system in which a steering device and a turning device are connected by a signal, a method of controlling a reaction torque applied to a steering wheel, and a program that causes a computer to execute processing for controlling the reaction torque.

### Background Art

There is known a so-called steer-by-wire system in which a steering device and a turning device are connected by a signal. JP2005-297667A discloses a conventional technique relating to control of a reaction applied to a steering wheel in the steer-by-wire system. This prior art executes wall reaction control for increasing an increase rate of a steering reaction when an actual turning angle of wheels approaches a maximum turning angle of the wheels. When the driver performs a turning-further operation on the steering wheel, the steering reaction rapidly rises due to the wall reaction control, so that the driver feels that the turning-further operation cannot be performed any more.

### SUMMARY

As a method of applying the steering reaction, a method of increasing a reaction torque as the steering angle increases may be considered. However, when the reaction torque is rapidly increased as in the case of the wall reaction control of the prior art described above, a shock is given to the driver gripping the steering wheel, and the operational feeling of the driver is deteriorated.

On the other hand, if the reaction torque is gradually increased in accordance with the steering angle before the steering angle reaches an end angle instead of rapidly increasing the reaction torque, the shock given to the driver can be alleviated. However, in this method, when the driver changes the operation on the steering wheel from a turning-further operation to a turning-back operation, the reaction torque acts in the direction of returning the steering wheel. This may cause the steering wheel to return excessively beyond the intention of the driver. Excessive return of the steering wheel also reduces the operation feeling of the driver.

The present disclosure has been made in view of the above-described problems. It is an object of the present disclosure to provide a technique for improving an operation feeling of a driver in both a turning-further operation and a turning buck operation on a steering wheel in a steering system of a vehicle in which a steering device including the steering wheel and a turning device that turns wheels are connected by a signal.

The present disclosure provides a vehicle steering system. The vehicle steering system according to the present disclosure includes a steering device, a turning device, a reaction device, and a controller. The steering device is configured to output a signal corresponding to a steering angle of a steering wheel. The turning device is configured to turn wheels based on the signal input from the steering device. The reaction device is configured to exert a reaction torque on the steering wheel. The controller is configured to control the reaction device.

The controller is programmed to execute predetermined processing. The processing executed by the controller includes setting a virtual end angle corresponding to a turning limit of the turning device with respect to the steering angle. The processing executed by the controller includes gradually increasing, when the steering angle approaches the virtual end angle, the reaction torque as the steering angle approaches the virtual end angle. The processing executed by the controller includes reducing, when the steering angle deviates from the virtual end angle, the reaction torque with respect to a change in the steering angle at a steeper gradient than a gradient of a change in the reaction torque with respect to a change in the steering angle when the steering angle approaches the virtual end angle.

The processing executed by the controller may include limiting an amount of change per time of the reaction torque when the operation direction of the steering wheel is changed. The processing performed by the controller may include changing the virtual end angle according to a state of the vehicle or according to a manual operation of a driver.

The present disclosure provides a reaction torque control method. The reaction torque control method according to the present disclosure is a method for controlling a reaction torque applied from a reaction device to a steering wheel in a steering system in which a turning device turns wheels based on a signal corresponding to a steering angle of the steering wheel input from a steering device. The reaction torque control method according to the present disclosure includes setting a virtual end angle corresponding to a turning limit of the turning device with respect to the steering angle. The reaction torque control method according to the present disclosure includes gradually increasing, when the steering angle approaches the virtual end angle, the reaction torque as the steering angle approaches the virtual end angle. The reaction torque control method according to the present disclosure includes decreasing, when the steering angle deviates from the virtual end angle, the reaction torque with respect to a change in the steering angle at a steeper gradient than a gradient of a change in the reaction torque with respect to a change in the steering angle when the steering angle approaches the virtual end angle.

The present disclosure provides a non-transitory computer-readable storage medium. The non-transitory computer-readable storage medium according to the present disclosure stores a program. The program is configured to cause a computer to execute processing for controlling a reaction torque applied from a reaction device to a steering wheel in a steering system in which a turning device turns wheels based on a signal corresponding to a steering angle of the steering wheel input from a steering device. The processing that the program causes the computer to execute includes setting a virtual end angle corresponding to a turning limit of the turning device with respect to the steering angle. The process that the program causes the computer to execute includes gradually increasing, when the steering angle approaches the virtual end angle, the reaction torque as the steering angle approaches the virtual end angle. The process that the program causes the computer to execute includes decreasing, when the steering angle deviates from the virtual end angle, the reaction torque with respect to a change in the steering angle at a steeper gradient than a gradient of a change in the reaction torque with respect to a change in the steering angle when the steering angle approaches the virtual end angle.

According to the technique of the present disclosure described above, when the steering angle approaches the virtual end angle corresponding to the turning limit of the turning device, the reaction torque acting on the steering wheel gradually increases as the steering angle approaches the virtual end angle. As a result, the shock applied to the driver who performs a turning-further operation on the steering wheel is suppressed. On the other hand, when the steering angle deviates from the virtual end angle, the reaction torque acting on the steering wheel decreases at a steep gradient with respect to the change in the steering angle. As a result, it is possible to prevent the steering wheel from excessively returning beyond the intention of the driver who performs a turning-back operation on the steering wheel. In other words, according to the technique of the present disclosure, it is possible to improve the operation feeling of the driver in both the turning-further operation and the turning-back operation on the steering wheel.

### BRIEF DESCRIPTION OF THE DRAWINGS

FIG. 1 is a diagram showing a schematic configuration of a vehicle steering system according to an embodiment of the present disclosure.

FIG. 2 is a block diagram showing a configuration of a controller of the vehicle steering system shown in FIG. 1.

FIG. 3A is a steering angle-reaction torque graph illustrating a reaction torque control method at a time of a turning-further operation on a steering wheel according to the embodiment of the present disclosure.

FIG. 3B is a steering angle-reaction torque graph illustrating a reaction torque control method at a time of a turning-back operation on the steering wheel according to the embodiment of the present disclosure.

FIG. 4 is a diagram showing a first configuration example of the reaction torque control unit shown in FIG. 2.

FIG. 5 is a diagram showing a second configuration example of the reaction torque control unit shown in FIG. 2.

FIG. 6 is a steering angle-reaction torque graph illustrating an outline of virtual end angle control according to the embodiment of the present disclosure.

### DETAILED DESCRIPTION

Hereinafter, embodiments of the present disclosure will be described with reference to the drawings. However, in the embodiments described below, when a numerical value such as the number, quantity, amount, range, or the like of each element is mentioned, the idea according to the present disclosure is not limited to the mentioned numerical value except for a case where the numerical value is clearly specified in particular or a case where the numerical value is obviously specified to the numerical value in principle. In addition, a structure or the like described in the following embodiments is not necessary to the idea according to the present disclosure except for a case where the structure or the like is clearly specified in particular or a case where the structure or the like is obviously specified in principle.

### 1. Overview of Vehicle Steering System

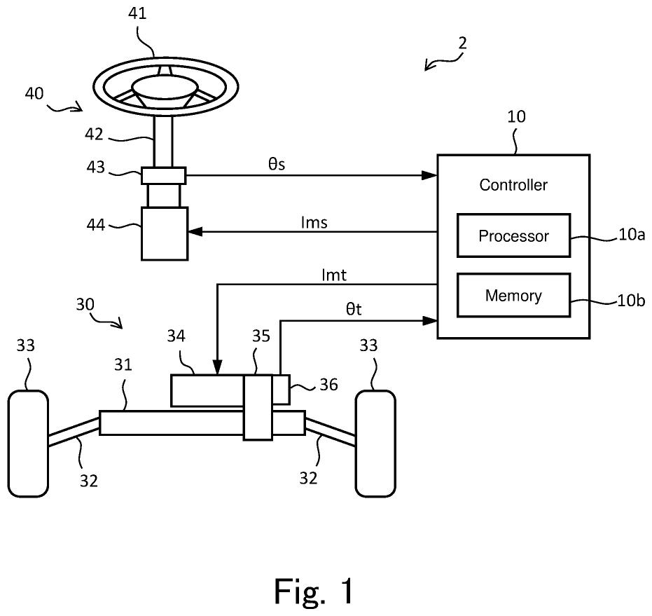

FIG. 1 shows a schematic configuration of a vehicle steering system 2 according to the present embodiment. The vehicle steering system 2 includes a steering device 40, a turning device 30, and a controller 10. The steering device 40 includes a steering wheel 41 to which a steering operation of the driver is input. The turning device 30 has a mechanism that turns wheels (steerable wheels) 33. The steering device 40 and the turning device 30 are mechanically separated from each other and are connected to each other by signals via the controller 10. In other words, the vehicle steering system 2 is a steer-by-wire system that causes the turning device 30 to turn the wheels 33 based on a signal output from the steering device 40.

The steering device 40 includes a steering wheel 41 and a steering shaft 42 that supports the steering wheel 41. The steering shaft 42 is provided with a steering angle sensor 43 that outputs a signal corresponding to a rotation angle of the steering wheel 41, that is, a steering angle θs.

A reaction motor 44 for applying a reaction torque to the steering wheel 41 is attached to the steering shaft 42. The reaction motor 44 is connected to the steering shaft 42 via a speed reduction mechanism (not shown). The reaction motor 44 and the speed reduction mechanism constitute a reaction device. The reaction motor 44 is supplied with the motor drive current Ims to generate torque, and the torque acts on the steering wheel 41 as the reaction torque.

The turning device 30 includes a turning motor 34 that turns the wheels 33. The turning motor 34 is attached to a rack shaft 31 via a speed reduction mechanism 35. The rack shaft 31 is not mechanically coupled to the steering shaft 42. The wheels 33 are coupled to the rack shaft 31 via tie rods 32. The turning angle of the wheels 33 is changed via the tie rods 32 by rotating the turning motor 34 to linearly move the rack shaft 31 in the axial direction thereof. The turning motor 34 is supplied with the motor drive current Imt to generate torque. A turning angle sensor 36 that outputs a signal corresponding to a turning angle θt of the wheels 33 is attached to the turning motor 34.

The controller 10 is a computer having at least one processor 10a and at least one memory 10b. The memory 10b stores various kinds of information including maps and programs. When the processor 10a reads at least one program from the memory 10b and executes the read program, functions to be described later are realized in the controller 10. Note that the computer constituting the controller 10 may be, for example, one electronic control unit (ECU), or may be an aggregate of a plurality of ECUs.

The controller 10 is connected to each of the steering device 40 and the turning device 30 by signals. The controller 10 acquires a signal corresponding to the steering angle θs from the steering angle sensor 43, and supplies the motor drive current Ims to the reaction motor 44. Further, the controller 10 acquires a signal corresponding to the turning angle θt from the turning angle sensor 36, and supplies a motor drive current Imt to the turning motor 34.

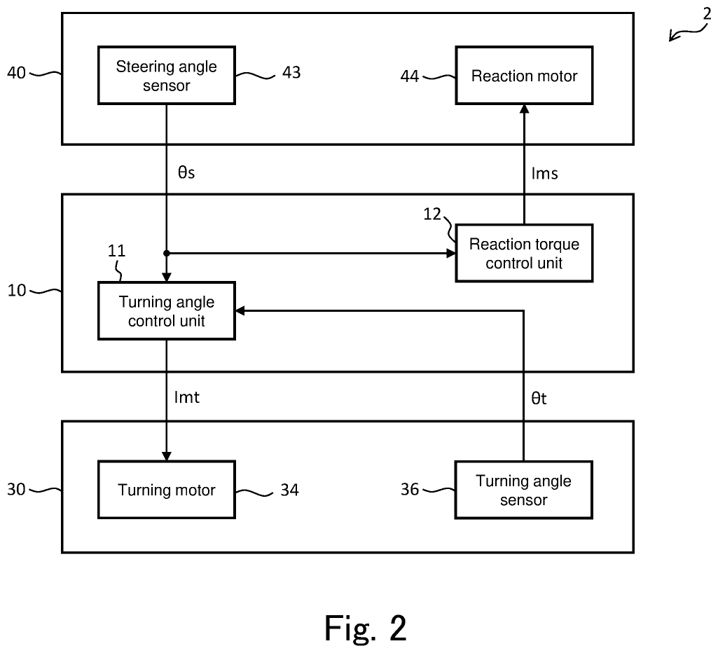

FIG. 2 is a block diagram showing the configuration of the controller 10 shown in FIG. 1. The controller 10 includes a turning angle control unit 11 and a reaction torque control unit 12. These control units 11 and 12 of the controller 10 correspond to the programs or parts thereof stored in the memory 10b of the controller 10. The functions of these control units 11 and 12 are realized in the controller 10 by the programs being read from the memory 10b and being executed by the processor 10a. The function of each of the control units 11 and 12 will be described below.

The turning angle control unit 11 first converts the steering angle θs obtained from the signal of the steering angle sensor 43 into a target turning angle. The target turning angle is a target value of the turning angle to be achieved by the control of the turning motor 34. A gear ratio is used to convert the steering angle into the target turning angle. The steering device 40 and the turning device 30 are not connected to each other via a gear mechanism. However, in this specification, for the sake of convenience, the ratio between the amount of change in the steering angle and the amount of change in the turning angle is referred to as a gear ratio. As the gear ratio decreases, the ratio of the amount of change in the turning angle to the amount of change in the steering angle increases. Therefore, the turning angle changes more quickly in response to the operation of the steering wheel 41 by the driver. The gear ratio is variable depending on, for example, the steering angle and the vehicle speed.

The turning angle control unit 11 calculates a motor drive current Imt for achieving the target turning angle. Specifically, the turning angle control unit 11 calculates the motor drive current Imt based on the difference between the turning angle θt fed back from the turning angle sensor 36 and the target turning angle, and supplies the motor drive current Imt to the steering motor 34.

The reaction torque control unit 12 calculates the motor drive current Ims based on the steering angle θs obtained from the signal of the steering angle sensor 43, and supplies the motor drive current Ims to the reaction motor 44. A reaction torque map is used for the calculation of the motor drive current Ims by the reaction torque control unit 12. The reaction torque map is a map in which the reaction torque generated by the reaction motor 44 is defined in relation to the steering angle. In the next section, a reaction torque control method by the reaction torque control unit 12 will be described.

### 2. Reaction Torque Control Method

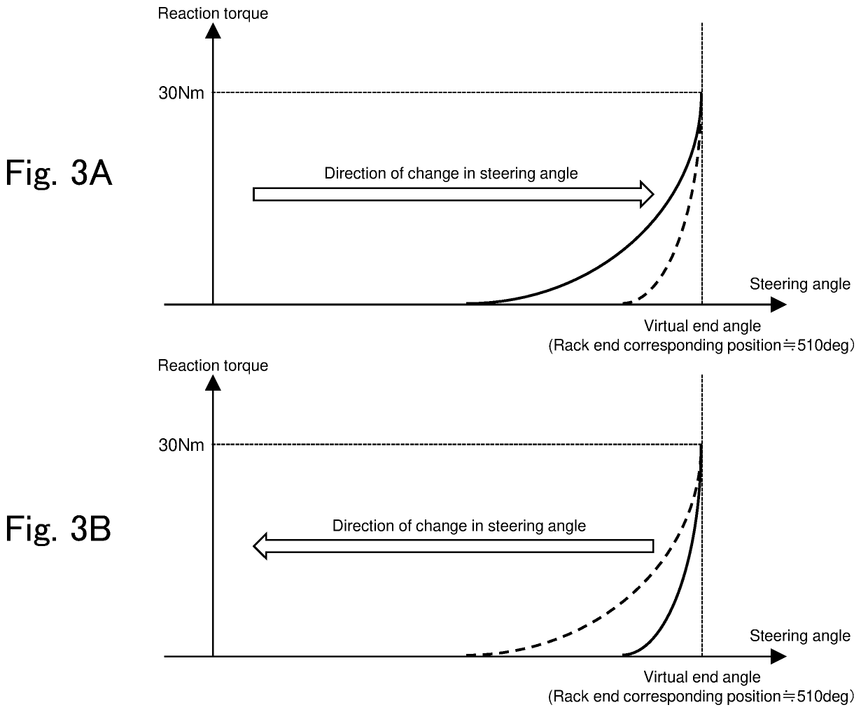

FIGS. 3A and 3B are steering angle-reaction torque graphs for explaining the reaction torque control method according to the present embodiment. In the reaction torque map used by the reaction torque control unit 12, the relationship between the steering angle and the reaction torque as shown in these graphs is mapped.

The reaction torque control unit 12 uses different reaction torque maps between when the turning-further operation on the steering wheel 41 is performed and when turning-back operation on the steering wheel 41 is performed. FIG. 3A is a graph showing the relationship between the steering angle and the reaction torque in the reaction torque map used at the time of the turning-further operation on the steering wheel 41. FIG. 3B is a graph showing the relationship between the steering angle and the reaction torque in the reaction torque map used at the time of the turning-back operation on the steering wheel 41.

As shown in each graph, the reaction torque applied to the steering wheel 41 by the reaction motor 44 is determined in accordance with the steering angle of the steering wheel 41. A position corresponding to the end of the rack shaft 31 (rack end corresponding position) is shown on the axis of the steering angle in each graph. The rack end corresponding position is a steering angle in a case where it is assumed that the rack shaft 31 moves to an end contact. An example of the rack end corresponding position is 510 deg.

In a steering system in which a steering device and a turning device are mechanically coupled to each other, a reaction is generated when a rack shaft contacts an end contact in the turning device, and a reaction torque that prevents further steering acts on a steering wheel. However, in the steer-by-wire system in which the steering device 40 and the turning device 30 are not mechanically coupled to each other, no reaction acts on the steering device 40 from the turning device 30.

Therefore, as shown in each graph, the reaction torque control unit 12 increases the reaction torque applied from the reaction motor 44 to the steering wheel 41 in the vicinity of the rack end corresponding position. By greatly increasing the reaction torque, the steering wheel 41 is prevented from being steered beyond the steering angle at which the reaction torque is increased. In other words, the steering angle at which the reaction torque is increased becomes the limit steering angle at which the driver can steer. Since the turning device 30 turns the wheels 33 in accordance with the steering angle of the steering wheel 41, the turning angling determined from the limit steering angle becomes the turning limit of the turning device 30. The turning limit is not a mechanically determined turning angle but a virtual turning limit set by software. Therefore, in the present specification, a steering angle that virtually gives the turning limit is referred to as a virtual end angle. In each graph, the rack end corresponding position is set as the virtual end angle.

However, the reaction torque control unit 12 gradually changes the reaction torque with respect to the steering angle so that a sudden increase in the reaction torque does not cause the driver to feel uncomfortable. Specifically, the reaction torque control unit 12 sets a rising start angle of the reaction torque to a position closer to the neutral position than the virtual end angle, and gradually increases the reaction torque in accordance with an increase in the steering angle from the rising start angle to the virtual end angle. The maximum value of the reaction torque, that is, the reaction torque at the rack end corresponding position which is the virtual end angle is set to, for example, 30 Nm.

The difference between the graph shown in FIG. 3A and the graph shown in FIG. 3B is the rising start angle of the reaction torque and the gradient of the change in the reaction torque with respect to the change in the steering angle. In FIG. 3A, the relationship between the steering angle and the reaction torque shown in FIG. 3B is indicated by a dotted line, and in FIG. 3B, the relationship between the steering angle and the reaction torque shown in FIG. 3A is indicated by a dotted line. As can be seen from the comparison between the two graphs, the rising start angle of the reaction torque in the graph shown in FIG. 3B is closer to the virtual end angle than that in the graph shown in FIG. 3A. Further, the gradient of the change in the reaction torque with respect to the change in the steering angle in the graph shown in FIG. 3B is steeper than that in the graph shown in FIG. 3A.

By setting the relationship between the steering angle and the reaction torque as described above, the following effects can be obtained at the time of the turning-further operation and the turning-back operation on the steering wheel 41.

When the driver performs the turning-further operation on the steering wheel 41, the reaction torque gradually increases as the steering angle approaches the virtual end angle as indicated by a solid line in FIG. 3A. If the reaction torque rises at a steep gradient in the vicinity of the virtual end angle as indicated by the dotted line in FIG. 3A, a shock is given to the driver gripping the steering wheel 41, and the operation feeling of the driver is deteriorated. However, when the reaction torque is gradually increased, the shock applied to the driver from the steering wheel 41 is suppressed, and the operation feeling of the driver is improved.

When the driver performs the turning-back operation on the steering wheel 41, the reaction torque decreases at a steep gradient when the steering angle deviates from the virtual end angle as indicated by a solid line in FIG. 3B. If the reaction torque gradually decreases from the virtual end angle as indicated by a dotted line in FIG. 3B, the reaction torque acts in a direction of returning the steering wheel 41. This may cause the steering wheel 41 to excessively return beyond the intention of the driver. Excessive return of the steering wheel 41 also deteriorates the operation feeling of the driver. However, when the reaction torque is decreased at a steep gradient, the steering wheel 41 is prevented from excessively returning beyond the intention of the driver who performs the turning-back operation on the steering wheel 41, and the operation feeling of the driver is improved.

The reaction torque control unit 12 switches between the reaction torque map shown in FIG. 3A and the reaction torque map shown in FIG. 3B according to a change in the operation direction of the steering wheel 41. When the operation direction of the steering wheel 41 is switched, the reaction torque control unit 12 limits the amount of change per time of the reaction torque. As a result, it is possible to suppress a sudden change in the reaction torque accompanying the switching of the operation direction of the steering wheel 41. In the next section, a specific configuration example of the reaction torque control unit 12 will be described.

### 3. Configuration Example of Reaction Torque Control Unit

### 3-1. First Configuration Example

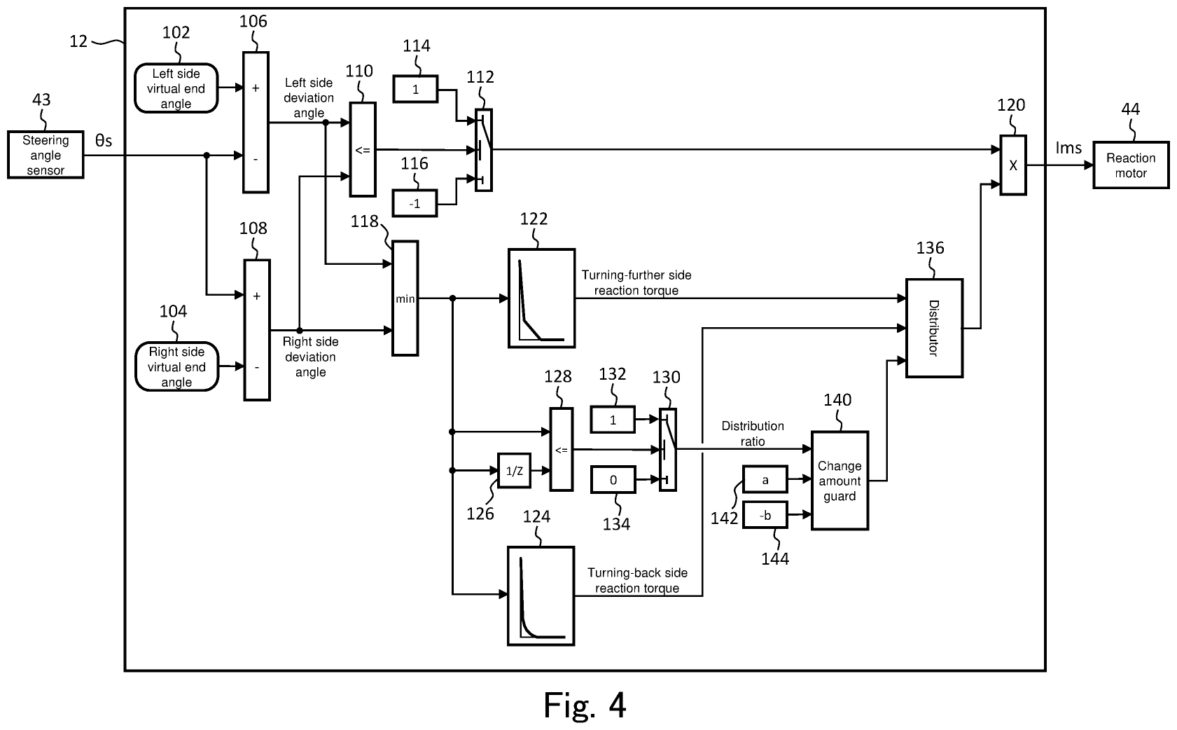

FIG. 4 shows a first configuration example of the reaction torque control unit 12. The steering angle θs acquired by the reaction torque control unit 12 from the steering angle sensor 43 is input to deviation angle calculators 106 and 108 in parallel. The deviation angle calculator 106 calculates a deviation angle (left side deviation angle) between the set value of the left side virtual end angle stored in a storage unit 102 and the steering angle θs. The deviation angle calculator 108 calculates a deviation angle (right side deviation angle) between the set value of the right side virtual end angle stored in a storage unit 104 and the steering angle θs.

The left side deviation angle and the right side deviation angle are input to a determiner 110. The determiner 110 outputs True when the left side deviation angle is equal to or less than the right side deviation angle, and outputs False when the left side deviation angle is greater than the right side deviation angle. When the output of the determiner 110 is True, it means that the steering wheel 41 is turned to the left of the neutral position. When the output of the determiner 110 is False, it means that the steering wheel 41 is turned to the right of the neutral position.

The output of the determiner 110 is input to a switch 112. The switch 112 is connected to a motor drive current calculator 120. When the output of the determiner 110 is True, the switch 112 switches a motor rotation direction setting value to be input to the motor drive current calculator 120 to the value “1” stored in a storage unit 114. When the output of the determiner 110 is False, the switch 112 switches the motor rotation direction setting value to be input to the motor drive current calculator 120 to the value “−1” stored in a storage unit 116.

Further, the left side deviation angle and the right side deviation angle are input to a minimum value selector 118. The minimum value selector 118 selects a smaller deviation angle (minimum deviation angle) between the left side deviation angle and the right side deviation angle, and outputs the selected minimum deviation angle. The minimum deviation angle is input to a turning-further side reaction torque map 122 and a turning-back side reaction torque map 124.

The turning-further side reaction torque map 122 is a map in which the relationship between the deviation angle of the steering angle with respect to the virtual end angle and the reaction torque, which is obtained from the relationship between the steering angle and the reaction torque shown in FIG. 3A, is defined. The turning-further side reaction torque map 122 is created such that the reaction torque gradually increases as the deviation angle decreases and approaches 0. A turning-further side reaction torque corresponding to the minimum deviation angle is output from the turning-further side reaction torque map 122.

The turning-back side reaction torque map 124 is a map in which the relationship between the deviation angle of the steering angle with respect to the virtual end angle and the reaction torque, which is obtained from the relationship between the steering angle and the reaction torque shown in FIG. 3B, is defined. The turning-back side reaction torque map 124 is created such that the reaction torque rapidly decreases as the deviation angle increases and deviates from 0. A turning-back side reaction torque corresponding to the minimum deviation angle is output from the turning-back side reaction torque map 124.

The minimum deviation angle is input to a determiner 128 together with a minimum deviation angle (delayed minimum deviation angle) delayed by one clock by a delay unit 126. The determiner 128 outputs True when the minimum deviation angle is equal to or smaller than the delayed minimum deviation angle, and outputs False when the minimum deviation angle is greater than the delayed minimum deviation angle. When the output of the determiner 128 is True, it means that the steering wheel 41 is being operated to turn further. When the output of the determiner 128 is False, it means that the steering wheel 41 is being operated to turn back.

The output of the determiner 128 is input to a switch 130. The switch 130 is connected to a distribution ratio change amount guard unit 140. When the output of the determiner 128 is True, the switch 130 switches a distribution ratio to be input to the distribution ratio change amount guard unit 140 to the value “1” stored in a storage unit 132. When the output of the determiner 128 is False, the switch 130 switches the distribution ratio to be input to the distribution ratio change amount guard unit 140 to the value “0” stored in a storage unit 134. The distribution ratio is a distribution ratio between the turning-further side reaction torque and the turning-back side reaction torque with respect to a final reaction torque. The distribution ratio of 1 means that the turning-further side reaction torque is set as the final reaction torque, and the distribution ratio of 0 means that the turning-back side reaction torque is set as the final reaction torque.

The distribution ratio change amount guard unit 140 limits the amount of change in the distribution ratio input from the switch 130, and outputs a distribution ratio with the limited change amount (post-guard distribution ratio). When the input distribution ratio is changed from 0 to 1, the value “a” stored in a storage unit 142 is used as the amount of change in the distribution ratio per predetermined time. That is, when the input distribution ratio changes from 0 to 1, the distribution ratio change amount guard unit 140 outputs the post-guard distribution ratio which is gradually increased from 0 to 1 by “a” per predetermined time. On the other hand, when the input distribution ratio is changed from 1 to 0, the value “−b” stored in a storage unit 144 is used as the amount of change in the distribution ratio per predetermined time. That is, when the input distribution ratio changes from 1 to 0, the distribution ratio change amount guard unit 140 outputs the post-guard distribution ratio which is gradually decreased from 1 to 0 by “−b” per predetermined time.

The turning-further-side reaction torque, the turning-back-side reaction torque, and the post-guard distribution ratio are input to a distributor 136. The distributor 136 calculates the reaction torque by the following equation. Where 13 is the post-guard distribution ratio in the following equation. The distributor 136 inputs the calculated reaction torque to the motor drive current calculator 120.

Reaction torque=β×turning-further side reaction torque+(1−β)×turning-back side reaction torque

The motor drive current calculator 120 determines the sign of the motor drive current Ims from the motor rotation direction setting value input from the switch 112, and calculates the magnitude of the motor drive current Ims from the reaction torque input from the distributor 136. The reaction torque control unit 12 supplies the motor drive current Ims calculated by the motor drive current calculator 120 to the reaction motor 44. When the sign of the motor drive current Ims is positive, the reaction motor 44 generates a reaction torque for rotating the steering wheel 41 in the right direction. When the sign of the motor drive current Ims is negative, the reaction motor 44 generates a reaction torque for rotating the steering wheel 41 in the left direction.

According to the first configuration example, since the distribution ratio change amount guard unit 140 limits the amount of change in the distribution ratio between the turning-further side reaction torque and the turning-back side reaction torque, it is possible to suppress a sudden change in the reaction torque accompanying the switching of the operation direction of the steering wheel 41.

### 3-2. Second Configuration Example

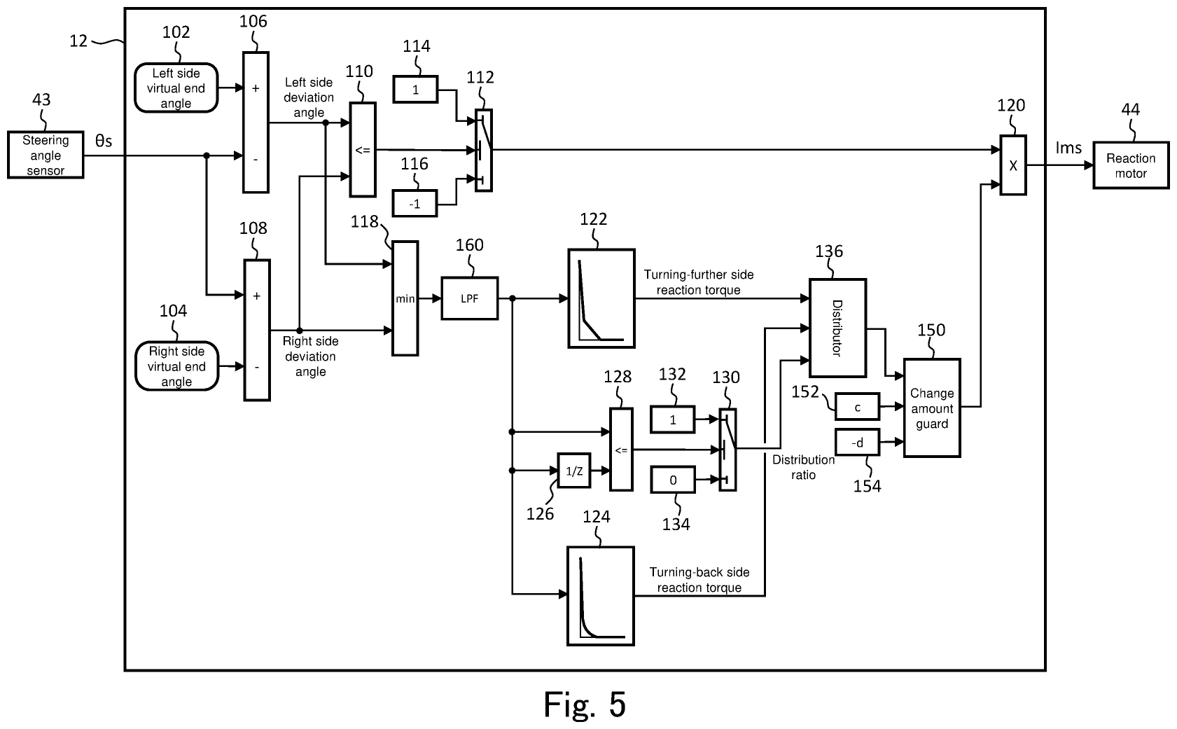

FIG. 5 shows a second configuration example of the reaction torque control unit 12. The first configuration example limits the amount of change in the distribution ratio, whereas the second configuration example limits the amount of change in the reaction torque after distribution. In the following description, among the components of the reaction torque control unit 12 shown in FIG. 5, the same components as those of the first configuration example already described will not be described or will be described briefly.

In the second configuration example, a low-pass filter 160 is arranged at the subsequent stage of the minimum value selector 118. The minimum deviation angle selected by the minimum value selector 118 is processed by the low-pass filter 160, and then input to the turning-further side reaction torque map 122, the turning-back side reaction torque map 124, the delay unit 126, and the determiner 128.

In the second configuration example, the distribution ratio output from the switch 130 is directly input to the distributor 136 together with the turning-further side reaction torque and the turning-back side reaction torque. The distributor 136 calculates the reaction torque by the following equation. Where a is the distribution ratio in the following equation. The distributor 136 inputs the calculated reaction torque to a reaction torque change amount guard unit 150.

Reaction torque=α×turning-further side reaction torque+(1−α)×turning-back side reaction torque

The reaction torque change amount guard unit 150 limits the amount of change in the reaction torque input from the distributor 136, and outputs the reaction torque with the limited change amount (post-guard reaction torque). When the input reaction torque increases, the value “c” stored in a storage unit 152 is used as the limit value of the amount of increase in the reaction torque per predetermined time. The reaction torque change amount guard unit 150 outputs the post-guard reaction torque whose increase amount is limited by the limit value “c”. On the other hand, when the input reaction torque decreases, the value “−d” stored in a storage unit 154 is used as the limit value of the amount of decrease in the reaction torque per predetermined time. The reaction torque change amount guard unit 150 outputs the post-guard reaction torque whose decrease amount is limited by the limit value “−d”.

The output of the reaction torque change amount guard unit 150 is input to the motor drive current calculator 120. The motor drive current calculator 120 determines the sign of the motor drive current Ims from the motor rotation direction setting value input from the switch 112, and calculates the magnitude of the motor drive current Ims from the post-guard reaction torque input from the reaction torque change amount guard 150.

According to the second configuration example, since the amount of change in the reaction torque is limited by the reaction torque change amount guard unit 150, it is possible to suppress a sudden change in the reaction torque accompanying the switching of the operation direction of the steering wheel 41.

### 4. Virtual End Angle Control

In the configuration example of the reaction torque control unit 12 shown in FIGS. 4 and 5, the left side virtual end angle stored in the storage unit 102 and the right side virtual end angle stored in the storage unit 104 can be set to arbitrary steering angles, respectively. Further, the left and right virtual end angles can be set to different steering angles.

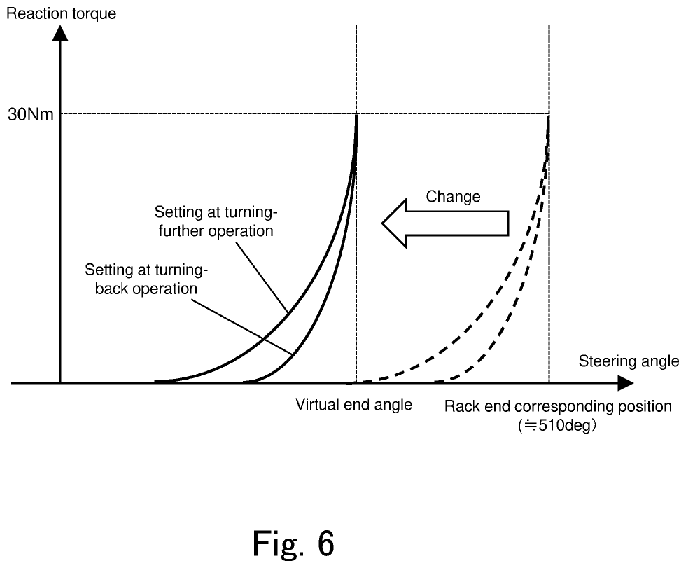

FIG. 6 is a steering angle-reaction torque graph for explaining the outline of the virtual end angle control. As shown in FIG. 6, in the virtual end angle control, the virtual end angle can be set to an arbitrary steering angle in accordance with, for example, a state of the vehicle or a manual operation of the driver.

When the virtual end angle is changed, the relationship between the steering angle and the reaction torque is also changed. However, regardless of the position of the virtual end angle, the rising start angle of the reaction torque at the time of the turning-back operation of the steering wheel 41 is closer to the virtual end angle than the rising start angle of the reaction torque at the time of the turning-further operation of the steering wheel 41. Further, regardless of the position of the virtual end angle, the gradient of the change in the reaction torque with respect to the change in the steering angle at the time of the turning-back operation of the steering wheel 41 is steeper than the gradient of the change in the reaction torque with respect to the change in the steering angle at the time of the turning-further operation of the steering wheel 41.

As long as the map defines the relationship between the reaction torque and the deviation angle between the virtual end angle and the steering angle, such as the turning-further side reaction torque map 122 and the turning-back side reaction torque map 124 shown in FIGS. 4 and 5, there is no need to change the map even when the virtual end angle is changed. That is, the configuration examples of the reaction torque control unit 12 shown in FIGS. 4 and 5 can also be applied to the virtual end angle control.

### 5. Other Embodiments

The vehicle steering system 2 in which the steering device 40 and the turning device 30 are connected by signals includes a remote driving system that remotely drives a vehicle using wireless communication, in addition to a steer-by-wire system. In the remote driving system, a signal is input from the steering device 40 installed at a remote place to the turning device 30 using wireless communication such as mobile communication. When the vehicle steering system 2 according to the present embodiment is a remote driving system, the controller 10 may be located in the vehicle together with the turning device 30, may be located in a remote operation center together with the steering device 40, or may be located in a server on the Internet. Alternatively, the functions of the controller 10 may be distributed to any two or all of the vehicle, the remote operation center, and the server.

What is claimed is:

1. A vehicle steering system comprising:
a steering device configured to output a signal corresponding to a steering angle of a steering wheel;
a turning device configured to turn wheels on a basis of the signal input from the steering device;
a reaction device configured to exert a reaction torque on the steering wheel; and
a controller configured to control the reaction device,
wherein the controller is programmed to execute:
setting a virtual end angle corresponding to a turning limit of the turning device with respect to the steering angle;
gradually increasing, when the steering angle approaches the virtual end angle, the reaction torque as the steering angle approaches the virtual end angle; and
decreasing, when the steering angle deviates from the virtual end angle, the reaction torque with respect to a change in the steering angle at a gradient than a gradient of a change in the reaction torque with respect to a change in the steering angle when the steering angle approaches the virtual end angle.

2. The vehicle steering system according to claim 1,
Wherein the controller is programmed to limit an amount of change per time of the reaction torque when an operation direction of the steering wheel is changed.

3. The vehicle steering system according to claim 1,
wherein the controller is programmed to change the virtual end angle according to a state of a vehicle or according to a manual operation of a driver.

4. A method for controlling a reaction torque applied from a reaction device to a steering wheel in a steering system in which a turning device turns wheels based on a signal corresponding to a steering angle of the steering wheel input from a steering device, the method comprising:
setting a virtual end angle corresponding to a turning limit of the turning device with respect to the steering angle;
gradually increasing, when the steering angle approaches the virtual end angle, the reaction torque as the steering angle approaches the virtual end angle; and
decreasing, when the steering angle deviates from the virtual end angle, the reaction torque with respect to a change in the steering angle at a steeper gradient than a gradient of a change in the reaction torque with respect to a change in the steering angle when the steering angle approaches the virtual end angle.

5. A non-transitory computer-readable storage medium storing a program for causing a computer to execute processing for controlling a reaction torque applied from a reaction device to a steering wheel in a steering system in which a turning device turns wheels based on a signal corresponding to a steering angle of the steering wheel input from a steering device, the processing comprising:
setting a virtual end angle corresponding to a turning limit of the turning device with respect to the steering angle;
gradually increasing, when the steering angle approaches the virtual end angle, the reaction torque as the steering angle approaches the virtual end angle; and
decreasing, when the steering angle deviates from the virtual end angle, the reaction torque with respect to a change in the steering angle at a steeper gradient than a gradient of a change in the reaction torque with respect to a change in the steering angle when the steering angle approaches the virtual end angle.
